(19) United States
(12) Patent Application Publication
(10) Pub. No.: US 2019/0340522 A1
(43) Pub. Date: Nov. 7, 2019

(54) EVENT PREDICTION SYSTEM, EVENT PREDICTION METHOD, RECORDING MEDIA, AND MOVING BODY

(71) Applicant: Panasonic Intellectual Property Management Co., Ltd., Osaka (JP)

(72) Inventors: TOSHIYA MORI, Osaka (JP); SHOHEI HAYASHI, Kyoto (JP)

(21) Appl. No.: 16/509,525

(22) Filed: Jul. 12, 2019

Related U.S. Application Data
(63) Continuation of application No. PCT/JP2018/001493, filed on Jan. 19, 2018.

(30) Foreign Application Priority Data
Jan. 23, 2017 (JP) 2017-009547

(51) Int. Cl. G06N 5/04; G06N 20/00

(52) U.S. Cl. CPC G06N 5/04; B60W 30/095; G06N 20/00

(57) ABSTRACT

Event prediction system includes accumulation unit and model generator. Accumulation unit accumulates a plurality of pieces of data for learning including history information. The history information indicates a situation of moving body at the time of occurrence of an event related to driving of moving body. Model generator generates a prediction model for predicting occurrence of the event with the plurality of pieces of data for learning. The history information includes raster data for learning. The raster data for learning indicates, with a plurality of cells, the situation of moving body at the time of occurrence of the event.

### CROSS-REFERENCE TO RELATED APPLICATIONS

This application is a continuation of the PCT International Application No. PCT/JP2018/001493 filed on Jan. 19, 2018, which claims the benefit of foreign priority of Japanese patent application No. 2017-009547 filed on Jan. 23, 2017, the contents all of which are incorporated herein by reference.

### TECHNICAL FIELD

The present disclosure generally relates to event prediction systems, event prediction methods, programs, and moving bodies, and in detail, relates to an event prediction system, an event prediction method, program, and a moving body that predict occurrence of an event related to driving of a moving body.

### BACKGROUND ART

Conventionally, a driving assistance device is known which assists driving of a vehicle by predicting danger to a one's vehicle and informing a driver of a predicted result (see PTL 1, for example).

The driving assistance device disclosed in PTL 1 includes a driving ability checking unit, a danger prediction unit, and a display controller. The driving ability checking unit periodically conducts a driving skills test on the basis of information detected by an environment information acquisition unit, a one's vehicle information acquisition unit, and a driver information acquisition unit, and checks driving skills of a driver by determining driving behavior of the driver from the test result of the driving skills test. The danger prediction unit predicts danger to the one's vehicle on the basis of the determination result on the driving behavior of the driver. The display controller predicts a future position of the one's vehicle on the basis of the information detected by the environment information acquisition unit, the one's vehicle information acquisition unit, and the driver information acquisition unit, and displays the future position of the one's vehicle on a display unit in a display form corresponding to the degree of riskiness of collision of the one's vehicle.

### CITATION LIST

### Patent Literature

PTL 1: Unexamined Japanese Patent Publication No. 2012-128655

### SUMMARY OF THE INVENTION

An object of the present disclosure is to provide an event prediction system, an event prediction method, a program, and a moving body that can predict also occurrence of an event due to an object in a blind spot of a driver.

An event prediction system according to a first aspect includes an accumulation unit and a model generator. The accumulation unit accumulates a plurality of pieces of data for learning including history information. The history information indicates a situation of a moving body at the time of occurrence of an event related to driving of the moving body. The model generator generates a prediction model for predicting occurrence of the event with the plurality of pieces of data for learning. The history information includes raster data for learning. The raster data for learning indicates, with a plurality of cells, the situation of the moving body at the time of occurrence of the event.

In an event prediction system according to a second aspect, the history information in the first aspect further includes at least one of information about an object in a surrounding area of the moving body; information about a state of the moving body; and information about a position of the moving body.

In an event prediction system according to a third aspect, each of the plurality of pieces of data for learning in the first or the second aspect further includes label information indicating an occurrence place of the event.

An event prediction system according to a fourth aspect further includes, in any one of the first to third aspects, a data generator and a prediction unit. The data generator generates raster data for prediction that indicates a situation of the moving body with a plurality of cells and with information for prediction about the moving body. The prediction unit predicts occurrence of the event during driving of the moving body, with the prediction model and the raster data for prediction.

In an event prediction system according to a fifth aspect, the data generator generates, in the fourth aspect, current raster data at the time of acquisition of the information for prediction, as the raster data for prediction. The prediction unit predicts occurrence of the event at generation of the current raster data.

In an event prediction system according to a sixth aspect, the data generator generates, in the fourth or fifth aspect, future raster data as the raster data for prediction on the basis of the current raster data at the time of acquisition of the information for prediction and the information for prediction. The future raster data is data after a predetermined time has elapsed from when the current raster data is generated. The prediction unit predicts the occurrence of the event at the time of the generation of the future raster data.

An event prediction system according to a seventh aspect further includes, in any one of the fourth to sixth aspects, a notification unit that notifies of a predicted result of the event.

An event prediction system according to an eighth aspect, the notification unit has, in the seventh aspect, a display unit that notifies of the predicted result of the event by displaying the predicted result.

An event prediction system according to a ninth aspect, the prediction unit is configured, in any one of the fourth to eighth aspects, to use the prediction model that is different for each attribute of a driver driving the moving body.

An event prediction system according to a tenth aspect further includes a data generator and a prediction unit. The data generator generates raster data for prediction that indicates a situation of a moving body with a plurality of cells and with information for prediction about the moving body. The prediction unit predicts occurrence of an event, related to driving of the moving body, during driving of the moving body with a prediction model and the raster data for prediction. The prediction model is generated with a plurality of pieces of data for learning including history information indicating a situation of the moving body at the time of occurrence of the event. The history information includes raster data for learning that indicates the situation of the moving body at the time of occurrence of the event, with a plurality of cells.

An event prediction method according to an eleventh aspect includes accumulation processing and model generation processing. The accumulation processing accumulates a plurality of pieces of data for learning including history information. The history information indicates a situation of a moving body at the time of occurrence of an event related to driving of the moving body. The model generation processing generates a prediction model for predicting occurrence of the event with the plurality of pieces of data for learning. The history information includes raster data for learning that indicates the situation of the moving body at the time of occurrence of the event, with a plurality of cells.

A program according to a twelfth aspect is a program for causing a computer system to execute accumulation processing and model generation processing. The accumulation processing accumulates a plurality of pieces of data for learning including history information. The history information indicates a situation of a moving body at the time of occurrence of an event related to driving of the moving body, and has raster data for learning. The raster data for learning indicates, with a plurality of cells, the situation of the moving body at the time of occurrence of the event. The model generation processing generates a prediction model for predicting occurrence of the event with the plurality of pieces of data for learning.

An event prediction method according to a thirteenth aspect has data generation processing and prediction processing. The data generation processing generates raster data for prediction that indicates a situation of a moving body with a plurality of cells and with information for prediction about the moving body. The prediction processing predicts occurrence of an event, related to driving of the moving body, during driving of the moving body with a prediction model and the raster data for prediction. The prediction model is generated with a plurality of pieces of data for learning including history information indicating a situation of the moving body at the time of occurrence of the event. The history information includes raster data for learning that indicates the situation of the moving body at the time of occurrence of the event, with a plurality of cells.

A program according to a fourteenth aspect is a program for causing a computer system to execute data generation processing and prediction processing. The data generation processing generates raster data for prediction that indicates a situation of a moving body with a plurality of cells and with information for prediction about the moving body. The prediction processing predicts occurrence of an event, related to driving of the moving body, during driving of the moving body with a prediction model and the raster data for prediction. The prediction model is generated with a plurality of pieces of data for learning including history information. The history information indicates a situation of the moving body at the time of occurrence of the event and has raster data for learning. The raster data for learning indicates, with a plurality of cells, the situation of the moving body at the time of occurrence of the event.

A moving body according to a fifteenth aspect includes the event prediction system according to any one of the first to tenth aspects.

The present disclosure has an advantage that the present disclosure can predict occurrence of an event due to an object in a blind spot of a driver.

### BRIEF DESCRIPTION OF DRAWINGS

FIG. 1 is a block diagram showing a configuration of an event prediction system according to a first exemplary embodiment.

FIG. 2 is a conceptual diagram showing an example of raster data for prediction in the event prediction system of the first exemplary embodiment.

FIG. 3 is a flowchart showing an operation related to generation of a prediction model in the event prediction system of the first exemplary embodiment.

FIG. 4 is a flowchart showing an operation of predicting an event in the event prediction system of the first exemplary embodiment.

FIG. 5 is a conceptual diagram showing an example of setting of an event occurrence place in current raster data in the event prediction system of the first exemplary embodiment.

FIG. 6 is a conceptual diagram showing a viewing field of a driver when the event prediction system of the first exemplary embodiment is used.

FIG. 7A is a conceptual diagram showing an event predictable by the event prediction system of the first exemplary embodiment.

FIG. 7B is a conceptual diagram showing an event predictable by the event prediction system of the first exemplary embodiment.

FIG. 7C is a conceptual diagram showing an event predictable by the event prediction system of the first exemplary embodiment.

FIG. 8A is a conceptual diagram showing another event predictable by the event prediction system of the first exemplary embodiment.

FIG. 8B is a conceptual diagram showing another event predictable by the event prediction system of the first exemplary embodiment.

FIG. 8C is a conceptual diagram showing another event predictable by the event prediction system of the first exemplary embodiment.

FIG. 9A is a conceptual diagram showing an example of label information in the event prediction system of the first exemplary embodiment.

FIG. 9B is a conceptual diagram showing an example of label information in the event prediction system of the first exemplary embodiment.

FIG. 10 is a conceptual diagram showing an example of future raster data generated by a data generator in an event prediction system according to a second exemplary embodiment.

FIG. 11 is a conceptual diagram showing an example of an event occurrence place in current raster data in the event prediction system of the second exemplary embodiment.

### DESCRIPTION OF EMBODIMENTS

Prior to describing exemplary embodiments of the present disclosure, problems of the conventional device will be briefly described. Since the driving assistance device described in PTL 1 informs a driver of a possibility of collision by displaying a predicted result at a future position of a one's vehicle, a content that can be informed to the driver is limited to an event (accident and the like) to be caused in an area visible by the driver. Therefore, the driving assistance device described in PTL 1 cannot predict an event due to an object (pedestrian in this case) in a blind spot of the driver such as a pedestrian suddenly appearing from behind a vehicle parked on a road.

### First Exemplary Embodiment

### (1) Outline

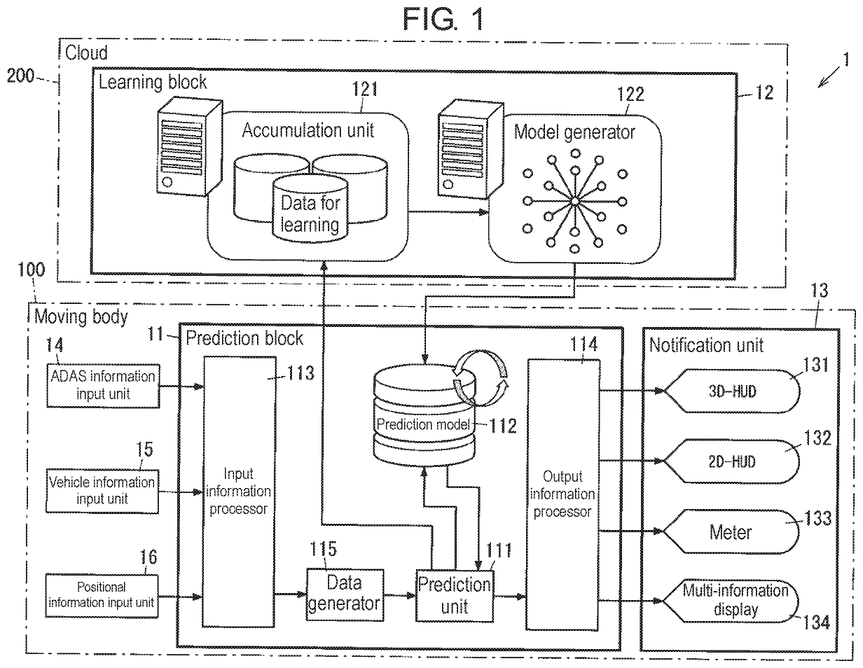

Event prediction system 1 according to the present exemplary embodiment (see FIG. 1) is a system for predicting occurrence of an event related to driving of moving body 100 such as an automobile (see FIG. 1). In the present exemplary embodiment, a description will be given on an example in which moving body 100 to which event prediction system 1 is applied is an automobile.

The “event” here means, for example, an event about which a driver driving moving body 100 feels dangerous. The “event” of such a type includes, for example, a collision between vehicles, a collision of a vehicle against a structure such as a guardrail, an accident such as a contact between a pedestrian or the like and a vehicle, and an event that is not an accident but has a high possibility of directly leading to an accident (so-called near-miss incident). Further, the “event occurrence place” here means a place where an event occurs, and includes both of places (spots) such as intersections, crosswalks, and the like where an event occurs and specific objects (parts) such as vehicles, pedestrians, small animals, and the like in a surrounding area of moving body 100 to which an event may occur.

Event prediction system 1 according to the present exemplary embodiment mainly predicts occurrence of an event due to an object in a blind spot of a driver. An specific example of this type of event includes a pedestrian suddenly appearing from behind a vehicle parked on a road and an appearance of a vehicle traveling straight from behind a vehicle waiting for right turn (or left turn). Such types of events, which occur outside a range visible from a driver, are also called “invisible dangers”. A driver of moving body 100 generally predicts these types of events (invisible dangers), referring to the driver's experience, on the basis of a situation of moving body 100, in other words, on the basis of what situation moving body 100 is in. That is, the driver generally becomes to be able to predict “invisible dangers” to an extent after experiencing driving of moving body 100 in various situations. Therefore, the predictability of “invisible dangers” varies largely depending on driving skills and driving senses of a driver, conditions of a driver (including psychological condition and the like of the driver), and the like.

Since event prediction system 1 mainly predicts these types of events (invisible dangers), it is possible to reduce the variation of the predictability of “invisible dangers” depending on driving skills and driving senses of a driver, conditions of a driver, and the like. Therefore, for example, when the driver has relatively little driving experience, the driver can drive while considering a possibility of occurrence of such types of events. In addition, even when a driver is less concentrated than usual due to, for example, fatigue and lack of sleep, the driver can drive while considering a possibility of occurrence of such types of events. Further, for example, when a driver simply looks away or is distracted, the driver can take some time finding occurrence of an event. In such a situation, the driver can promptly notice a possibility of occurrence of an event and can therefore drive more safely. As described above, since event prediction system 1 can predict also occurrence of an event due to an object in a blind spot of a driver, prediction system 1 can assist the driver to drive moving body 100 so that driver can drive more safely.

Event prediction system 1 according to the present exemplary embodiment predicts occurrence of an event with a prediction model generated, for example, from history information indicating a situation of moving body 100 at the time of actual occurrence of an event and from other information, with a machine learning algorithm. That is, instead of driving experience of a driver, a prediction model, which is generated from history information indicating a situation of moving body 100 and from other information, makes it possible to predict occurrence of an event. For example, it is possible to predict occurrence of an event from various situations of moving body 100, such as what types of objects are in the surrounding area of moving body 100, how fast moving body 100 is traveling, and where moving body 100 is traveling.

The predicted result of an event in event prediction system 1 is preferably notified to the driver by being displayed on, for example, a head-up display (HUD), a multi-information display, or other displays. With this arrangement, when an event due to an object in a blind spot of a driver is predicted to occur, the possibility is informed to the driver; therefore, for example, even a driver having relatively little driving experience can drive while concerning the possibility of occurrence of such a type of event. In addition, even when a driver is less concentrated than usual due to, for example, fatigue and lack of sleep, the driver can drive while considering a possibility of occurrence of such types of events. Further, for example, when a driver simply looks away or is distracted, the driver can take some time finding occurrence of an event. In such a situation, the driver can promptly notice a possibility of occurrence of an event and can therefore drive more safely.

### (2) Configuration

As shown in FIG. 1, event prediction system 1 according to the present exemplary embodiment includes prediction block 11 assembled on moving body 100 (automobile, in the present exemplary embodiment) and learning block 12 assembled in cloud 200 (cloud computing).

Event prediction system 1 further includes notification unit 13 mounted on moving body 100. Event prediction system 1 further includes ADAS (Advanced Driver Assistance System) information input unit 14, vehicle information input unit 15, and positional information input unit 16 that are mounted on moving body 100.

Prediction block 11 and learning block 12 are configured to be communicable with each other. Since prediction block 11 is assembled in moving body 100, prediction block 11 communicates with learning block 12 assembled in cloud 200 through, for example, a mobile phone network (carrier's network) provided by a telecommunications carrier or a public line network such as the Internet. Examples of the mobile phone network include, for example, the third-generation (3G) line, the long-term evolution (LTE) line, and the like. Prediction block 11 may be configured to be communicable with learning block 12 through a public wireless local area network (LAN).

Prediction block 11 has prediction unit 111, model storage 112, input information processor 113, output information processor 114, and data generator 115. Prediction block 11 is configured with a computer system configured mainly with, for example, a central processing unit (CPU) and a memory, and the computer system functions as prediction block 11 when the CPU executes a program stored in the memory. Although the program is previously recorded in the memory of prediction block 11, the program may be provided through an electric telecommunication line such as the Internet or provided being recorded in a recording medium such as a memory card.

Input information processor 113 is connected to ADAS information input unit 14, vehicle information input unit 15, and positional information input unit 16 and acquires moving body information. The “moving body information” here is information indicating a situation of moving body 100. In the present exemplary embodiment, the moving body information includes all of the following information: information about an object in a surrounding area of moving body 100 (also referred to as “ADAS information”); information about a state of moving body 100 (also referred to as “vehicle information”); and information about a position of moving body 100 (also referred to as “positional information”). ADAS information input unit 14, vehicle information input unit 15, and positional information input unit 16 are respectively input interfaces for ADAS information, vehicle information, and positional information. Therefore, to input information processor 113, the ADAS information is input from ADAS information input unit 14, the vehicle information is input from vehicle information input unit 15, and the positional information is input from positional information input unit 16. In the present exemplary embodiment, input information processor 113 outputs the ADAS information, the vehicle information, and the positional information as information for prediction (to be described later) to data generator 115. That is, in the present exemplary embodiment, the moving body information and the information for prediction include all of the ADAS information, the vehicle information, and the positional information. Note that the moving body information may include at least one of the ADAS information, the vehicle information, and the positional information. Similarly, the information for prediction may include at least one of the ADAS information, the vehicle information, and the positional information.

The ADAS information can be detected by the following detectors of the advanced driver assistance system (ADAS): a camera, a sonar sensor, a radar, a light detection and ranging (LiDAR); and the like. Specific examples of the ADAS information includes a distance from moving body 100 to a vehicle traveling in a surrounding area of moving body 100, a relative coordinate of the vehicle with respect to moving body 100, inter-vehicular distances between a plurality of vehicles, relative velocities of these vehicles, and the like. In this case, objects in the surrounding area of moving body 100 in the ADAS information include a vehicle traveling or stopped in the surrounding area of moving body 100, a structure such as a guardrail or the like, in addition, a pedestrian, and a small animal.

The vehicle information indicates local conditions of moving body 100 itself and can be detected by a sensor mounted on moving body 100. Specific examples of the vehicle information include a traveling velocity (running velocity) of moving body 100, acceleration applied to moving body 100, a stepping amount (degree of opening of an accelerator) of an accelerator pedal, a stepping amount of a brake pedal, and a steering angle, in addition, a pulse rate, a facial expression, an eye-gaze, and the like, of the driver, detected by a driver monitor. In addition, the vehicle information also includes specific data of moving body 100 such as a vehicle width, a vehicle height, an overall length, and an eye point.

The positional information is based on a position of moving body 100 and includes road information at the one's vehicle position and other information that can be detected with global positioning system (GPS).

Specific examples of the positional information include the following information about the road on which the one's vehicle position: a number of traffic lanes; whether the road is an intersection; whether the road is a T-shaped intersection; whether the road is a one-way traffic road; a roadway width; whether there is a sidewalk; a slope; and a curvature of a curve.

Specific examples of each of the ADAS information, the vehicle information, and the positional information are not limited to the above-mentioned examples. For example, if the driver monitor can detect a direction of a face, a sleepiness, and an emotion, and the like of the driver, these pieces of information (the direction of the face, the sleepiness level, the emotion, and the like of the driver) are included in the vehicle information.

Data generator 115 is configured to generate raster data for prediction with information for prediction about moving body 100. In the present exemplary embodiment, data generator 115 generates current raster data at the time of acquisition of the information for prediction, as raster data for prediction. Data generator 115 outputs the generated raster data for prediction to prediction unit 111. The “information for prediction” here indicates a situation of moving body 100 and is the same information as the moving body information acquired by input information processor 113. The “raster data for prediction” here indicate a situation of moving body 100 with a plurality of cells. More specifically, raster data for prediction is configured with cells (pixels) arranged in a lattice shape (grid shape) of rows and columns, and each pixel includes various types of information about moving body 100. In the present exemplary embodiment, raster data for prediction corresponds to image data when moving body 100 and a surrounding area of moving body 100 are looked down from above. In the present exemplary embodiment, each pixel corresponds to a square area whose size is 1 m in height and 1 m in width.

Each pixel includes, as a numerical value, information such as a relative coordinate of the pixel when the position of moving body 100 is defined as an origin (control point), identification information of an object (for example, a vehicle, a motor bike, a human, or the like) within the pixel, a relative velocity of the object within the pixel with respect to moving body 100. In an example of the present exemplary embodiment, an X-Y orthogonal coordinate system is used as a relative coordinate of a pixel with respect to moving body 100, and in the X-Y orthogonal coordinate system, the lateral direction of moving body 100 is X-axis and the longitudinal direction of moving body 100 is Y-axis. The right-hand direction along X-axis when viewed from moving body 100 is assumed to be “positive”, and the distal direction along Y-axis when viewed from moving body 100 is assumed to be “positive”. Since moving body 100 has a certain size in a plan view (area), one point on moving body 100 (for example, a central point in the plan view) is set as an origin (X, Y=0, 0), to be exact.

Each pixel includes, as a numerical value, information about: a position of a traffic lane; and a road on which moving body 100 is travelling, such as a roadway, a sidewalk or a crosswalk, and, in addition, information about: types of vehicles including moving body 100 and other vehicles than moving body 100; and a state of a brake lamp. Further, each pixel may include, as a numerical value, information about moving body 100 itself, for example: a traveling velocity (running velocity) of moving body 100; an acceleration applied to moving body 100; a stepping amount of an accelerator pedal; a stepping amount of a brake pedal; and a steering angle. Further, each pixel may include, as a numerical value, information about, for example, a lighting state of a traffic light. In addition, each pixel may include, as a numerical value, a pulse rate, a facial expression of a driver, and an eye-gaze, and the like of a driver. Further, as already described above, if the driver monitor can detect a direction of a face, a sleepiness, and an emotion, and the like of the driver, each pixel may include, as a numerical value, these pieces of information (the direction of the face, the sleepiness level, the emotion, and the like of the driver).

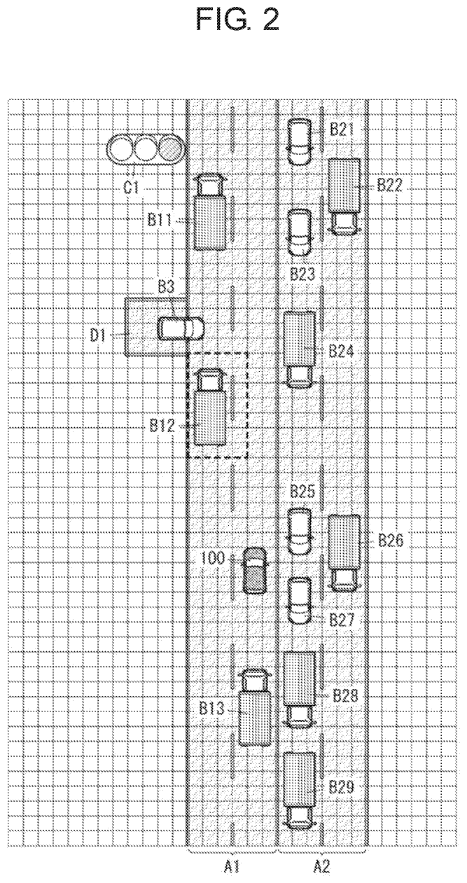

FIG. 2 is a conceptual diagram showing an example of raster data for prediction. FIG. 2 is a bird's eye view of moving body 100 (one's vehicle) and a surrounding area of moving body 100. FIG. 2 shows driving lane A1 on which moving body 100 is traveling and oncoming driving lane A2. Driving lane A1 and oncoming driving lane A2 each has two traffic lanes. On driving lane A1 there are shown a plurality of (here, three) objects (here, vehicles B11 to B13). On oncoming driving lane A2 there are shown a plurality of (here, nine) objects (here, vehicles B21 to B29). In addition, beside driving lane A1 there is shown traffic light C1. Further, the drawing also shows an object (here, vehicle B3) that is about to enter the roadway from parking space D1 adjacent to driving lane A1.

Here, the conceptual diagram of raster data for prediction shown in FIG. 2 is made by visualizing raster data for prediction. Therefore, the conceptual diagram shown in FIG. 2 shows, in a visualized form, information visible to a human eye, for example, an object including a vehicle or the like, a road, and a traffic light; however, the conceptual diagram does not show information invisible to a human eye, for example, a relative velocity of a vehicle with respect to moving body 100.

Prediction unit 111 is configured to predict occurrence of an event during driving of moving body 100 with a prediction model and a raster data for prediction generated by data generator 115. In the present exemplary embodiment, prediction unit 111 is configured to predict occurrence of an event at the time of generation of the raster data for prediction (current raster data). The “prediction model” here is a learned model generated in learning block 12, with a machine learning algorithm, from history information or the like indicating the situation of moving body 100 upon an actual occurrence of an event.

Further, prediction unit 111 estimates an event occurrence place with the prediction model. In an example, prediction unit 111 is configured to estimate in raster data for prediction, as an event occurrence place, a pixel in which an object to which an event is predicted to occur is located, including the pixels in a surrounding area of the object. In the present exemplary embodiment, the event occurrence place is calculated by prediction unit 111 (i) to be a relative coordinate of a referential pixel of a group of pixels to which an event is predicted to occur and (ii) to be width dimensions (unit: pixel) of the group of pixels in the X-axis direction and the Y-axis direction. The “event occurrence place” includes, as mentioned above, a place such as an intersection, a crosswalk, or the like where an event occurs, and also includes a specific object with respect to which an event is considered and which includes, for example, a vehicle, a pedestrian, and a small animal in the surrounding area of moving body 100; however, estimation is performed for the latter (specific objects) in the present exemplary embodiment. A specific processing of prediction unit 111 will be described in the section of “(3. 2) Predicting operation”.

Time prediction unit 111 is configured to transmit, to learning block 12, the history information indicating the situation of moving body 100 at occurrence of the event. The “history information” here indicates the situation of moving body 100 and includes the same information as the moving body information (and the information for prediction) acquired by input information processor 113. That is, in the present exemplary embodiment, the history information includes all of the following information: information about an object in a surrounding area of moving body 100 (ADAS information); information about a state of moving body 100 (vehicle information); and information about a position of moving body 100 (positional information). Naturally, the history information may include at least one of the ADAS information, the vehicle information, and the positional information. The history information includes raster data for learning that indicates the situation of moving body 100 at the time of occurrence of the event, with a plurality of cells. The “raster data for learning” here is the same information as the raster data for prediction at the time of occurrence of the event. However, the raster data for learning does not have to have the same size as the raster data for prediction and may be data generated by resizing the raster data for prediction with identification information of an object, for example. Note that, when ADAS information, vehicle information, and positional information are included in the raster data for prediction, the history information may be configured with only raster data for learning.

Note that prediction unit 111 does not always transmit the history information to learning block 12 but transmits the history information to learning block 12 only at occurrence of an event. Occurrence of an event can be detected from: detection results obtained by a sonar sensor, a radar, and the like; a state of operation of an air-bag; detection results of sudden braking and sudden steering; or a pulse, a facial expression, and the like of the driver measured by a driver monitor. That is, triggered by occurrence of an event, prediction block 11 transmits, to learning block 12, the history information during several seconds before and after the occurrence of the event, for example. In this case, when history information is acquired at predetermined time intervals (for example, 0.1 seconds), a plurality of pieces of history information acquired during several seconds before and after the occurrence of the event are collectively transmitted to learning block 12.

In this case, prediction unit 111 transmits, to learning block 12, label information indicating the event occurrence place together with the history information. In the present exemplary embodiment, the label information is (i) a relative coordinate of a referential pixel of the group of pixels to which an event is predicted to occur and (ii) width dimensions of the group of pixels in the X-axis direction and the Y-axis direction. The event occurrence place indicated by label information is not an event occurrence place predicted by prediction unit 111 but the occurrence place of an actual event when occurrence of the event is detected. When the plurality of pieces of history information are collectively transmitted to learning block 12, the label information is linked to each of the plurality of pieces of history information. Details will be described later, but the history information and the label information are used by learning block 12 to generate a prediction model.

Model storage 112 stores a prediction model to be used for prediction by prediction unit 111. In the present exemplary embodiment, the prediction model generated by learning block 12 is transmitted (delivered) from learning block 12 to prediction block 11 through communication between prediction block 11 and learning block 12 and is stored (memorized) in model storage 112. In the present exemplary embodiment, it is assumed that one prediction model is stored in model storage 112. Model storage 112 occasionally acquires a new prediction model from learning block 12 and occasionally updates a stored prediction model. However, model storage 112 may store a plurality of prediction models.

Output information processor 114 is connected to prediction unit 111 and notification unit 13. To output information processor 114, a predicted result of an event by prediction unit 111 is input. In the present exemplary embodiment, the event occurrence place estimated from the raster data for prediction and the prediction model is input to output information processor 114 as the predicted result of an event. Output information processor 114 outputs to notification unit 13 the result of the prediction by prediction unit 111 (here, the event occurrence place) and causes notification unit 13 to notify. In the present exemplary embodiment, notification unit 13 has a display unit that displays the predicted result of an event to notify. Therefore, output information processor 114 outputs to notification unit 13 the predicted result of an event as data in a form displayable on the display unit.

Notification unit 13 notifies of the event occurrence place estimated based on the raster data for prediction as the predicted result of an event. That is, in prediction unit 111, since the event occurrence place is estimated from the raster data for prediction, notification unit 13 receives the predicted result of an event from output information processor 114 and notifies of (displays, in the present exemplary embodiment) the event occurrence place. In the present exemplary embodiment, notification unit 13 has, as an example of the display unit, three-dimensional head-up display (3D-HUD) 131, two-dimensional head-up display (2D-HUD) 132, meter 133, and multi-information display 134. 3D-HUD 131 and 2D-HUD 132 each project an image onto a windshield of moving body 100 from below (dashboard) to make a driver visually recognize the image reflected by the windshield. In particular, 3D-HUD 131 can project an image visually recognized to have depth, on a road surface in front of moving body 100. A specific display form of notification unit 13 will be described in the section “(3. 2) Predicting operation”.

Learning block 12 has accumulation unit 121 and model generator 122. Learning block 12 is configured with a computer system configured mainly with, for example, a CPU and a memory, and the computer system functions as learning block 12 when the CPU executes a program stored in the memory. Although the program is previously recorded in the memory of learning block 12, the program may be provided through an electric telecommunication line such as the Internet or provided being recorded in a recording medium such as a memory card.

Accumulation unit 121 accumulates a plurality of pieces of data for learning including history information indicating a situation of moving body 100 at occurrence of an event. In the present exemplary embodiment, accumulation unit 121 accumulates, together with the history information, the label information transmitted from prediction unit 111 to learning block 12 as data for learning. That is, each of a plurality of pieces of data for learning accumulated in accumulation unit 121 includes the history information at the time of occurrence of an event and the label information indicating the event occurrence place.

As described above, triggered by occurrence of an event, accumulation unit 121 accumulates, as data for learning, the history information to which the label information is added. The data for learning is accumulated in accumulation unit 121 at every occurrence of an event, and a plurality of pieces of data for learning are accumulated in accumulation unit 121. In this case, the plurality of pieces of data for learning accumulated in accumulation unit 121 are a data set for learning to be used for generation of a prediction model by model generator 122. That is, the history information in the plurality of pieces of data for learning is subjected to annotation processing, and the plurality of pieces of data for learning thus constitute the data set for learning, where the data set for learning is suitably processed for machine learning by model generator 122.

Model generator 122 generates a prediction model with the plurality of pieces of data for learning. Model generator 122 uses a certain amount or more of data for learning to generate the prediction model by the machine learning algorithm. The prediction model is a learned model to be used by prediction unit 111 to predict occurrence of an event, as mentioned above. The prediction model generated by model generator 122 is transmitted from learning block 12 to prediction block 11 and is stored in model storage 112. Here, model generator 122 has a sample for evaluation of a prediction model, and every time the evaluation of a prediction model becomes better, the prediction model is transmitted to prediction block 11 to update the prediction model stored in model storage 112.

### (3) Operation

Next, an operation of event prediction system 1 according to the present exemplary embodiment will be described.

### (3. 1) Learning Operation

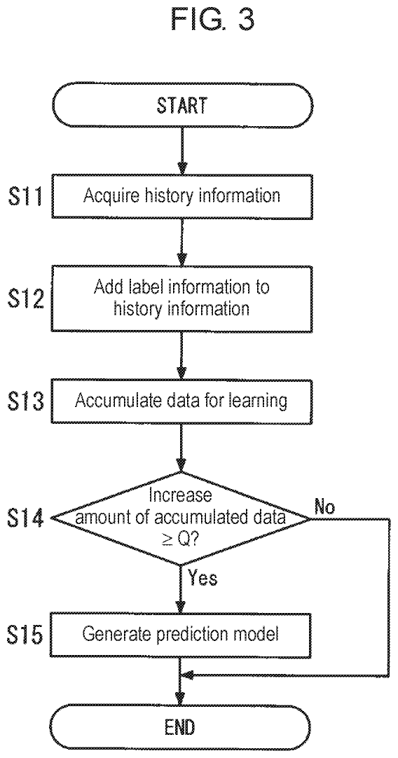

First, with reference to a flowchart shown in FIG. 3, a description will be given on an operation of event prediction system 1 related to generation of a prediction model in learning block 12.

Triggered by occurrence of an event in prediction block 11, learning block 12 acquires history information from prediction block 11 (step S11). At this time, learning block 12 further acquires, together with the history information, the label information associate with the history information. Learning block 12 performs annotation processing of adding the acquired label information to the history information (step S12). Learning block 12 accumulates, in accumulation unit 121, the thus acquired history information, to which the label information is added, as data for learning (step S13).

Learning block 12 compares a predetermined value Q with an increase amount of accumulated data (for example, a bit count), which indicates the increase amount in the accumulated data for learning (step S14). If the increase amount of accumulated data is greater than or equal to the predetermined value Q (step S14: Yes), learning block 12 generates a prediction model by model generator 122 (step S15). At this time, model generator 122 generates, by a machine learning algorithm, a prediction model with the plurality of pieces of data for learning accumulated in accumulation unit 121. The prediction model generated by model generator 122 is transmitted from learning block 12 to prediction block 11 and is stored in model storage 112. On the other hand, if the increase amount of accumulated data is less than the predetermined value Q (step S14: No), event prediction system 1 skips step S15 and finishes a series of processing steps in learning block 12.

Event prediction system 1 generates a prediction model by repeatedly performing processing steps of steps S11 to S15 every time an event occurs in prediction block 11. Then, every time the evaluation of a prediction model becomes better, learning block 12 transmits the prediction model to prediction block 11 to update the prediction model stored in model storage 112.

Learning block 12 is preferably configured as follows: a plurality of pieces of data for learning are previously accumulated in accumulation unit 121 at the time of starting of operation of event prediction system 1 so that a prediction model can be generated without acquiring history information from prediction block 11. The above applies to prediction models, and a default prediction model is preferably stored in each of learning block 12 and model storage 112 at the time of starting of operation of event prediction system 1.

### (3. 2) Predicting Operation

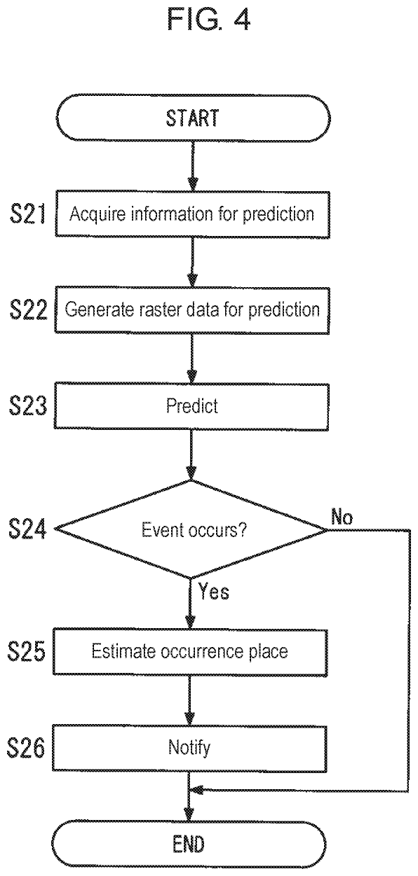

Next, a predicting operation in event prediction system 1 will be described with reference to a flowchart shown in FIG. 4.

Prediction block 11 acquires information for prediction by prediction unit 111 (step S21). At this time, ADAS information, vehicle information, and positional information that are respectively input from ADAS information input unit 14, vehicle information input unit 15, and positional information input unit 16 into input information processor 113, and is input into prediction unit 111 as information for prediction. Prediction block 11 uses the acquired information for prediction to generate, in data generator 115, current raster data as raster data for prediction (step S22). Then, prediction block 11 uses the generated raster data for prediction (current raster data) and the prediction model stored in model storage 112 to predict occurrence of an event by prediction unit 111 (step S23). The following processing is occasionally performed at a predetermined time interval (for example, 0.1 seconds): acquiring processing of information for prediction (step S21), data generation processing of raster data for prediction (step S22), and prediction processing of occurrence of an event (step S23).

If an event is predicted to occur by prediction unit 111 (step S24: Yes), prediction block 11 starts estimation processing to predict the occurrence place of the event with the prediction model (step S25). Specifically, prediction block 11 calculates, by prediction unit 111, (i) a relative coordinate of a referential pixel of a group of pixels to which the event is predicted to occur in the raster data for prediction (current raster data) and (ii) width dimensions of the group of pixels in the X-axis direction and the Y-axis direction. Then, prediction block 11 sets, by prediction unit 111, the group of pixels as an event occurrence place.

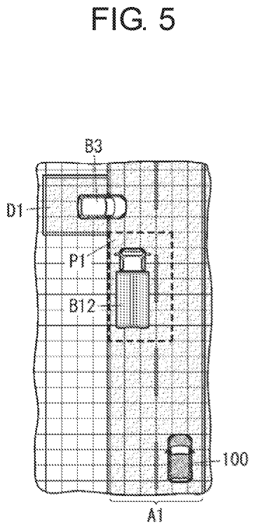

FIG. 5 is a conceptual diagram showing an example of setting of an event occurrence place. With reference to FIG. 5, the relative coordinate of the referential pixel of the group of pixels that is estimated to be the event occurrence place (see the area surrounded by a broken line in FIG. 5) is the relative coordinate of the pixel at the upper-left corner (the pixel indicated by “P1” in FIG. 5). In FIG. 5, regarding the group of pixels, the width dimension in the X-axis direction is 4 pixels, and the width dimension in the Y-axis direction is 7 pixels. In addition, in the group of pixels there is vehicle B12. Prediction block 11 sets, by prediction unit 111, the surrounding area of this vehicle B12 in the current raster data as the event occurrence place (see the area surrounded by a broken line in FIG. 2).

When the estimation processing (step S25) is completed, event prediction system 1 notifies of a predicted result of an event (that is, the event occurrence place set by prediction unit 111) by notification unit 13 (step S26).

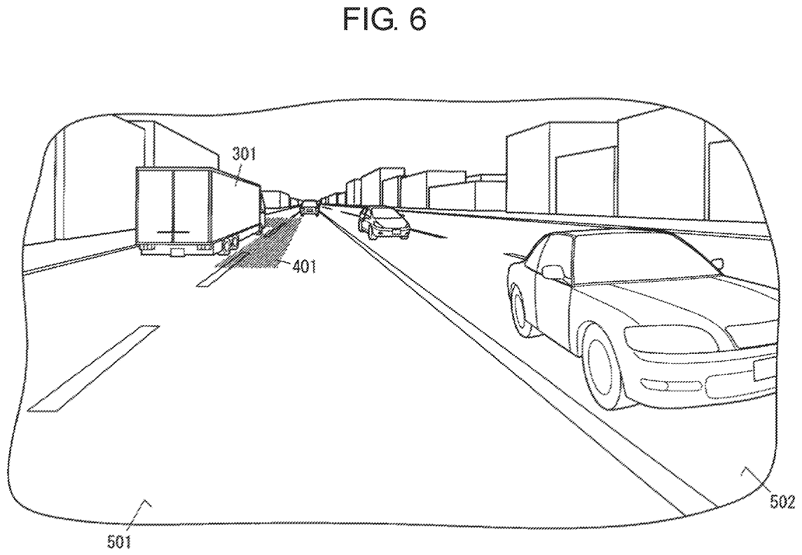

As an example, a description will be given on informing processing (step S26) by notification unit 13 in a situation as shown in FIG. 6. FIG. 6 is a conceptual diagram showing a viewing field of a driver of moving body 100. The example of FIG. 6 assumes that driving lane 501 on which moving body 100 (one's vehicle) is travelling and oncoming driving lane 502 are each a straight road having two traffic lanes. In this example, on a road shoulder of driving lane 501 on the left ahead of moving body 100 there is truck 301 parked. In the example of FIG. 6, marker 401 (the area indicated by hatching with dots) is displayed, by 3D-HUD 131, on the periphery of truck 301, which is set as the event occurrence place. By this display, the driver can see marker 401 superposed on the periphery of truck 301 and is thus facilitated to pay attention to truck 301. That is, in the viewing field of the driver, an augmented reality (AR) display is realized in which marker 401 displayed by 3D-HUD 131 is superposed on a real space.

This display enables the driver to confirm that there is “invisible danger” such as a pedestrian or a bicycle suddenly appearing from behind truck 301 that makes a blind spot of the driver. As described above, event prediction system 1 according to the present exemplary embodiment can assist a driver to drive moving body 100 so that safer driving can be achieved.

On the other hand, if prediction unit 111 does not predict that an event occurs (step S24: No), event prediction system 1 skips steps S25 and S26 and finishes the series of processing steps by prediction block 11.

### (4) Supplementary Note

Hereinafter, several examples of events (invisible dangers) that can be predicted by event prediction system 1 according to the present exemplary embodiment will be described. In this section, it is assumed that event prediction systems 1 displays an event occurrence place, including moving body 100 (one's vehicle), in an image viewed from above.

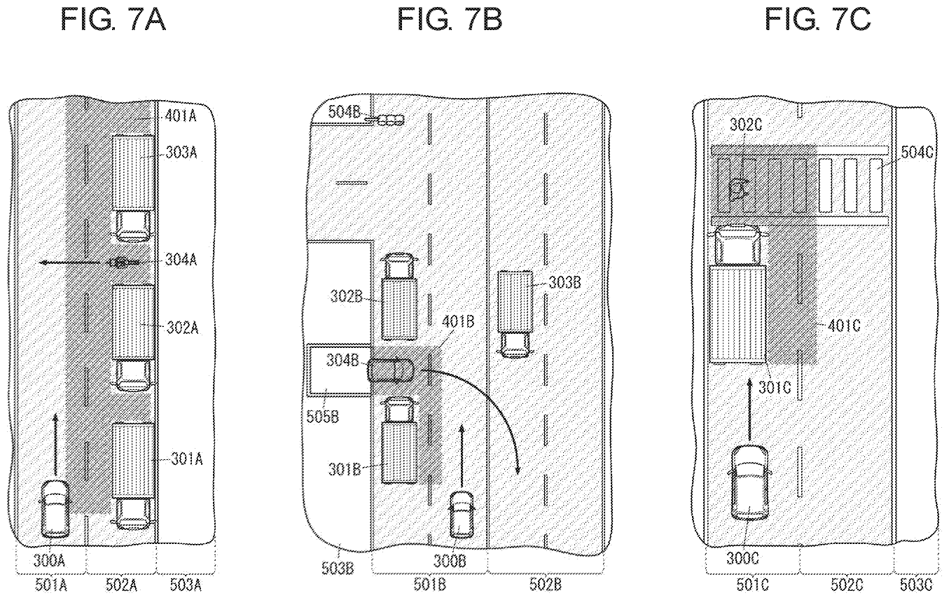

First, FIGS. 7A, 7B, and 7C each show a situation in which a bicycle, a vehicle, or a pedestrian can suddenly appear from behind an object (here, a stopped truck).

In the example of FIG. 7A, each of driving lane 501A on which one's vehicle 300A as moving body 100 is travelling and oncoming driving lane 502A has one traffic lane, and on the road shoulder of oncoming driving lane 502A there are a plurality of parked trucks 301A, 302A, 303A. In addition, bicycle 304A is about to cross driving lane 501A, passing through between truck 302A and truck 303A from sidewalk 503A on the oncoming driving lane 502A side. In the situation of FIG. 7A, event prediction system 1 determines, from information about, for example, distances between trucks 301A, 302A, 303A, that an “invisible danger” is lurking in the surrounding area of parked trucks 301A, 302A, 303A. Therefore, event prediction system 1 displays marker 401A in a peripheral area of parked trucks 301A, 302A, 303A. The situation illustrated in FIG. 7A can occur not only in the case where trucks 301A, 302A, 303A are parked but also in the case where, for example, where a plurality of trucks 301A, 302A, 303A stop or travel very slowly because of a traffic jam.

In the example of FIG. 7B, each of driving lane 501B on which one's vehicle 300B as moving body 100 is travelling and oncoming driving lane 502B has two traffic lanes. In this case, because traffic light 504B is red, there are a plurality of trucks 301B, 302B stopped (waiting at the traffic light) on the left ahead of one's vehicle 300B on driving lane 501B. In addition, truck 303B is traveling on oncoming driving lane 502B. In this case, vehicle 304B is about to move to oncoming driving lane 502B, passing through between truck 301B and truck 302B from parking space 505B on sidewalk 503B on the driving lane 501B side. In the situation of FIG. 7B, event prediction system 1 determines, from information about, for example, a distance between trucks 301B, 302B and traffic light 504B, that an “invisible danger” is lurking in the surrounding area of stopped truck 301B. Therefore, event prediction system 1 displays marker 401B in a peripheral area of stopped truck 301B.

In the example of FIG. 7C, each of driving lane 501C on which one's vehicle 300C as moving body 100 is travelling and oncoming driving lane 502C has one traffic lane, and on the road shoulder of driving lane 501C there is parked truck 301C. In this case, pedestrian 302C is crossing crosswalk 504C ahead of truck 301C toward sidewalk 503C on the oncoming driving lane 502C side. In the situation of FIG. 7C, event prediction system 1 determines, from information about, for example, a traveling velocity of truck 301C and crosswalk 504C, that there is an “invisible danger” lurking in the surrounding area of parked truck 301C. Therefore, event prediction system 1 displays marker 401C in a peripheral area of parked truck 301C.

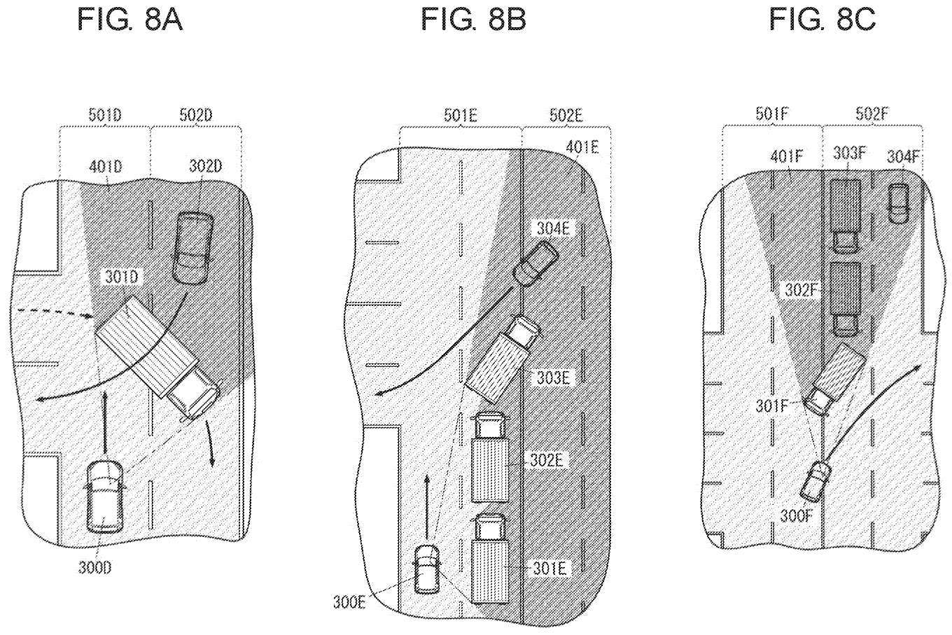

FIGS. 8A, 8B, 8C each show a situation in which there is a vehicle in the blind spot created by an object (truck, here).

In the example of FIG. 8A, each of driving lane 501D on which one's vehicle 300D as moving body 100 is travelling and oncoming driving lane 502D has one traffic lane, and at the intersection ahead of one's vehicle 300D there is truck 301D coming from the left while making a right turn. In addition, on oncoming driving lane 502D there is vehicle 302D waiting to turn right at the same intersection. In the situation of FIG. 8A, event prediction system 1 determines, from information about, for example, truck 301D and vehicle 302D, that there is an “invisible danger” lurking in the blind spot created by truck 301D. Therefore, event prediction system 1 displays marker 401D in the blind area created by truck 301D.

In the example of FIG. 8B, each of driving lane 501E on which one's vehicle 300E as moving body 100 is travelling and oncoming driving lane 502E has two traffic lanes, and at the intersection ahead of one's vehicle 300E there are a plurality of trucks 301E, 302E, 303E on driving lane 501E waiting to turn right. In addition, on oncoming driving lane 502E there is vehicle 304E waiting to turn right in the same intersection. In the situation of FIG. 8B, event prediction system 1 determines, from information about, for example, trucks 301E, 302E, 303E and vehicle 304E, that an “invisible danger” is lurking in a blind spot created by trucks 301E, 302E, 303E. Therefore, event prediction system 1 displays marker 401E in the blind area created by the plurality of trucks 301E, 302E, 303E.

In the example of FIG. 8C, each of driving lane 501F on which one's vehicle 300F as moving body 100 is travelling and oncoming driving lane 502F has two traffic lanes, and one's vehicle 300F is waiting in the intersection to turn right. In addition, in the same intersection there are a plurality of trucks 301F, 302F, 303F waiting on oncoming driving lane 502F to turn right. In addition, on oncoming driving lane 502F there is vehicle 304F travelling straight. In the situation of FIG. 8C, event prediction system 1 determines, from information about, for example, truck 301F at the top and vehicle 304F, that there is an “invisible danger” lurking in the blind spot created by truck 301F. Therefore, event prediction system 1 displays marker 401F in the blind area created by truck 301F.

### (5) Modified Examples

The first exemplary embodiment is merely one of various embodiments of the present disclosure. The first exemplary embodiment can be variously modified in accordance with, for example, a design as long as the object of the present disclosure can be achieved. For example, event prediction system 1 may include only a function to generate a prediction model for predicting occurrence of an event. In this case, event prediction system 1 does not have to include a function to generate raster data for prediction or a function to predict occurrence of an event from the raster data for prediction and from the prediction model. That is, in this case, prediction block 11 is not an essential component for event prediction system 1. In this case, event prediction system 1 may be configured to provide a prediction model to another system for, for example, predicting occurrence of an event from the prediction model.

For example, event prediction system 1 may include only a function to generate raster data for prediction and a function to predict occurrence of an event from the raster data for prediction and from the prediction model. In this case, event prediction system 1 does not have to include a function to generate the prediction model for predicting occurrence of an event. That is, in this case, learning block 12 for generating a prediction model is not an essential component for event prediction system 1. Further, in this case, event prediction system 1 may be configured to predict occurrence of an event from a prediction model with the prediction model provided from another system. In this case, as the prediction model, the before-described prediction model can be used.

Functions similar to those of event prediction system 1 may be embodied by, for example, an event prediction method, a computer program, or a storage medium storing a program. An event prediction method according to an aspect generates a prediction model and has accumulation processing and model generation processing. The accumulation processing accumulates a plurality of pieces of data for learning including history information. The model generation processing generates a prediction model for predicting occurrence of an event with the plurality of pieces of data for learning. The history information includes raster data for learning.

An event prediction method according to another aspect predicts occurrence of an event and has data generation processing and prediction processing. Data generation processing generates raster data for prediction, with information for prediction about moving body 100. The prediction processing predicts occurrence of an event during driving of moving body 100, with a prediction model and the raster data for prediction.

A (computer) program according to another aspect is a program for making a computer system execute processing for generating a prediction model, and is a program for making a computer system execute accumulation processing and model generation processing. The accumulation processing accumulates a plurality of pieces of data for learning including history information. The history information has raster data for learning. The model generation processing generates a prediction model for predicting occurrence of an event with the plurality of pieces of data for learning.

A program according to another aspect is a program for making execute processing to predict occurrence of an event and is a program for making a computer system execute data generation processing and prediction processing.

Data generation processing generates raster data for prediction, with information for prediction about moving body 100. The prediction processing predicts occurrence of an event during driving of moving body 100, with a prediction model and the raster data for prediction.

Hereinafter, modified examples of the first exemplary embodiment will be listed. The modified examples described below can be applied while being combined as appropriate.

### (5. 1) Example of Label Information

In the present exemplary embodiment, the label information is (i) a relative coordinate of a referential pixel of a group of pixels to which an event is predicted to occur and (ii) width dimensions of the group of pixels in the X-axis direction and the Y-axis direction; however, it is not intended to limit the label information thereto. For example, label information may be only the above-described relative coordinate of a pixel. The label information is not limited to the information indicating the group of pixels to which an event is predicted to occur, and may be information directly or indirectly indicating an event occurrence place. For example, the label information may be information indicating whether a group of pixels match an event pattern. The “event pattern” here is a group of pixels to which an event is predicted to occur.

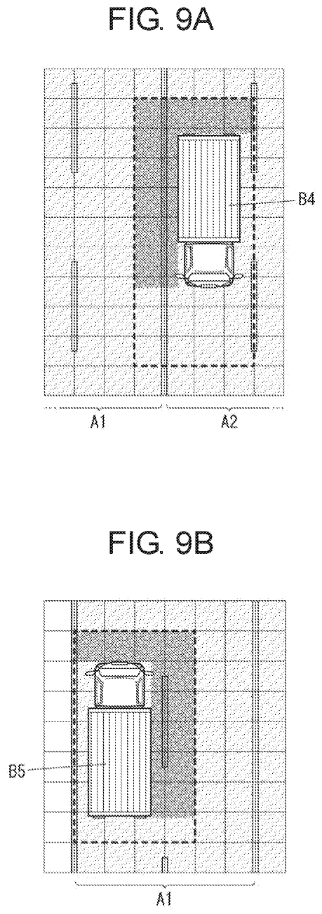

FIGS. 9A and 9B each shows an example of an event pattern. The event pattern shown in FIG. 9A is a group of pixels constituted by a part of driving lane A1 and oncoming driving lane A2 cut out from raster data for prediction, and vehicle B4 is indicated on oncoming driving lane A2. With reference to the event pattern shown in FIG. 9A, an event occurrence place is set in the surrounding area of vehicle B4 (see the area surrounded by a broken line in FIG. 9A). The event pattern shown in FIG. 9B is a group of pixels constituted by a part of driving lane A1 and oncoming driving lane A2 cut out from raster data for prediction, and vehicle B5 is indicated on driving lane A1. In the event pattern shown in FIG. 9B, an event occurrence place is set in the surrounding area of vehicle B5 (see the area surrounded by a broken line in FIG. 9B).

In a configuration in which information indicating whether an event pattern is matched is used as the label information, a prediction model has a plurality of event patterns. The plurality of event patterns include, in addition to previously set event patterns, an event pattern newly generated by machine learning. To raster data for learning there is added, as label information, information indicating whether the raster data for prediction matches an event pattern. For example, if raster data for prediction matches one event pattern of the plurality of event patterns, the raster data for learning corresponding to this raster data for prediction includes, as the label information, information indicating that the raster data for prediction matches a first pattern. For example, if raster data for prediction matches a plurality of patterns, the raster data for learning corresponding to this raster data for prediction includes, as the label information, information indicating that the raster data for prediction matches the plurality of patterns.

In this configuration, prediction block 11 predicts occurrence of an event by performing pattern matching, by prediction unit 111, between the raster data for prediction and plurality of event patterns of a prediction model. For example, it is assumed that the raster data for prediction includes a group of pixels that matches an event pattern shown in FIG. 9B. In this case, prediction block 11 sets this group of pixels as an event occurrence place by prediction unit 111. That is, in this configuration, prediction block 11 performs both of prediction processing (step S23) and estimation processing (step S25) by performing the above pattern matching by prediction unit 111.

### (5. 2) Other Modified Examples

An estimation result of an event occurrence place does not have to be notified by notification unit 13, and may output to, for example, a vehicle control system configured to control moving body 100. In this case, by operating a brake, an accelerator, steering, or the like depending on the estimation result of an event occurrence place, the vehicle control system can decelerate the moving body before the event occurs or maneuver around the event occurrence place. This allows the vehicle control system to achieve automatic driving (including both full self-driving and partial self-driving).

The raster data for prediction generated by data generator 115 includes information about moving body 100 and the surrounding area all around moving body 100; however, it is not intended to limit the raster data for prediction to such data. For example, the raster data for prediction may include only the information about a fore part (for example, a viewing field of a driver) of the surrounding area of moving body 100. That is, the information included in the raster data for prediction depends on information that can be acquired by moving body 100, for example, ADAS information, vehicle information, and positional information. Also in this case, prediction unit 111 can predict occurrence of an event from a prediction model. That is, for example, even if raster data for prediction that lacks a part of a plurality of kinds of information is used with respect to a prediction model generated with raster data for learning that includes the plurality of kinds of information, prediction unit 111 can predict occurrence of an event. In this case, prediction unit 111 may supplement missing information with, for example, a previously set initial value, an average value of past data, and the like.

The raster data for learning does not have to include all the information about moving body 100 and the surrounding area all around moving body 100 as shown in, for example, FIG. 2. For example, the raster data for learning may include only the information about a fore part of the surrounding area of moving body 100. Model generator 122 can generate a prediction model even when raster data for learning having such a little information is used.

Prediction unit 111 does not have to transmit the label information to learning block 12, and a part in prediction block 11 other than prediction unit 111 may transmit the label information to learning block 12. Further, the label information may be added to the history information on the side of prediction block 11 provided on moving body 100. In this case, learning block 12 occasionally accumulates, in accumulation unit 121, the history information having the label information received from prediction block 11. Further, the label information does not have to be transmitted from prediction block 11 to learning block 12, and the label information may be generated in learning block 12 with the history information received from prediction block 11. In this case, learning block 12 generates the label information and adds the label information to the history information.

Event prediction system 1 according to the first exemplary embodiment does not have to be embodied as a system having separate moving body 100 and cloud 200. For example, event prediction system 1 may be housed in one chassis or may be consolidated in moving body 100 or cloud 200. For example, when event prediction system 1 is consolidated in moving body 100, event prediction system 1 can generate a prediction model in moving body 100, in a stand-alone mode. In this case, for example, an electrically erasable and programmable read-only memory (EEPROM) and an electronic control unit (ECU) that are incorporated in moving body 100 respectively function as the accumulation unit and the generators. Each of the components of event prediction system 1 (accumulation unit 121, model generator 122, prediction unit 111, data generator 115, and the like) may be divided and provided on two or more devices. For example, model generator 122 may be divided and provided on moving body 100 and cloud 200.

Learning block 12 does not have to acquire history information, which constitutes data for learning, from one moving body 100, and may acquire (collect) from a plurality of moving bodies 100. In this case, learning block 12 uses the history information and the like acquired from the plurality of moving bodies 100 to generate a prediction model and transmits the generated prediction model to the plurality of moving bodies 100. In particular, in the case where learning block 12 acquires history information, which constitutes data for learning, from many moving bodies 100, an aggregation of acquired history information constitutes so-called big data.

Learning block 12 may be installed in, for example, an automobile dealer or a shop for maintenance and the like. In this case, learning block 12 can acquire history information from a plurality of moving bodies 100 maintained by the shop. A prediction model generated in learning block 12 is transmitted to prediction block 11 at the time of maintenance of moving body 100. This enables moving body 100 to update the prediction model at the time of maintenance. Further, learning block 12 may be embodied by a server device in, for example, a sales company or a manufacturer that manages a plurality of shops. In this case, learning block 12 can collectively manage history information acquired from a plurality of shops and generate a prediction model with these pieces of history information.

The information for prediction only has to be information indicating a situation of moving body 100 and does not have to be the same information as the moving body information acquired by input information processor 113. For example, in the moving body information, a traveling velocity calculated from positional information may be used in place of the traveling velocity of moving body 100 included in the vehicle information of information for prediction. Similarly, the history information only has to be information indicating the situation of moving body 100 and does not have to be the same information as the moving body information acquired by input information processor 113.

Notification unit 13 does not have to be configured to perform augmented reality display with 3D-HUD 131, and may perform, for example, text display or animation display with 2D-HUD 132, meter 133, multi-information display 134, or the like. Alternatively, notification unit 13 may perform augmented reality display by displaying, on a display of a car navigation system or another display, a video generated by superposing a marker on a video captured in real time by a front camera. Notification unit 13 may include a display unit configured with a wearable terminal such as a head mounted display (HMD).

Notification unit 13 does not have to notify by displaying an event occurrence place and may notify of the event occurrence place by, for example, voice, a haptic device, or a combination of them. A target of notification by notification unit 13 does not have to be a driver of moving body 100, and notification unit 13 may notify a vehicle traveling behind moving body 100 and a pedestrian in the surrounding area of moving body 100 by, for example, turning on lighting devices or blowing a horn.

It may depend on, for example, conditions of a driver (including a psychological condition) and the like whether to perform prediction by prediction unit 111 and notification by notification unit 13. For example, when a driver is less concentrated due to, for example, fatigue and lack of sleep, the driver sometimes has difficulty noticing a possibility of occurrence of an event. To address this issue, prediction unit 111 may be configured to perform prediction when, for example, it is determined that the driver drives more roughly than usual, based on an acceleration included in the vehicle information and applied to moving body 100 and based on a detection result of the driver monitor. Further, for example, notification unit 13 may be configured to perform notification when it is determined that the driver does not notice a possibility of occurrence of an event, from a detection result of a driver monitor. Further, a level on the basis of which notification unit 13 performs notification may be varied based on the conditions of the driver or the like.

The relative coordinate of a pixel does not have to be in a two-dimensional orthogonal coordinate system. For example, there may be used a polar coordinate system or a three-dimensional coordinate system with Z-axis added in a height direction (vertical direction) of moving body 100.

Notification unit 13 only has to notify of a predicted result of an event and does not have to have a configuration for notifying of an estimated event occurrence place as a predicted result of an event. For example, notification unit 13 may simply issue an alert or may notify of a distance from moving body 100 to an event occurrence place. In addition, notification unit 13 may notify of a required time to a predicted occurrence time of an event.

An event predicted by event prediction system 1 does not have to be an event (invisible dangers) due to an object in a blind spot of the driver. Event prediction system 1 may predict an event occurrence place that can be predicted without depending on situations of moving body 100, such as accident-prone spots, entrances and exits of tunnels, and tight curves.

Event prediction system 1 may use a communication technology of a so-called vehicle to everything (V2X) communication in which communication is performed between vehicles (inter-vehicle communication) or between a vehicle and an infrastructure such as a traffic light and a road sign. The V2X communication technology enables moving body 100 to acquire, for example, information for prediction to be used for prediction, of an event, in prediction unit 111 and other information, from a vehicle or an infrastructure in the surrounding area. Further, instead of notification unit 13, an infrastructure can notify of an event occurrence place. An infrastructure may perform estimation of an event occurrence place or the like, and, in this case, event prediction system 1 does not have to be mounted on moving body 100.

Event prediction system 1 can be applied not only to automobiles but also to moving bodies other than automobiles, such as motorcycles, trains, aircrafts, drones, construction machines, and ships. In addition, event prediction system 1 does not have to be used for moving bodies. For example, event prediction system 1 may be used in amusement facilities and may be used as a wearable terminal such as a head mounted display (HMD), medical equipment, and a stationary device.

### Second Exemplary Embodiment

Event prediction system 1 according to the present exemplary embodiment is different from event prediction system 1 according to the first exemplary embodiment in that data generator 115 of the present exemplary embodiment generates future raster data as raster data for prediction on the basis of current raster data and information for prediction. In addition, event prediction system 1 according to the present exemplary embodiment is different from event prediction system 1 according to the first exemplary embodiment in that prediction unit 111 of the present exemplary embodiment predicts occurrence of an event at the time of generation of future raster data. The “future raster data” here is raster data after a predetermined time (for example, several hundred seconds to several seconds) has elapsed from when current raster data is generated.

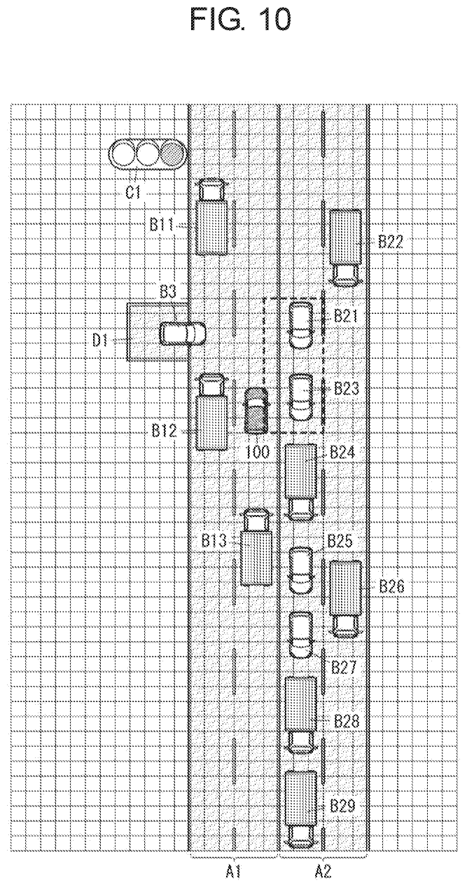

Hereinafter, a description will be given on a predicting operation of event prediction system 1 according to the present exemplary embodiment. Prediction block 11 generates, by data generator 115, future raster data on the basis of current raster data and information for prediction such as a traveling velocity (running velocity) of moving body 100 and a relative velocity of an object other than moving body 100 with respect to moving body 100. FIG. 10 shows a conceptual diagram showing an example of future raster data when a predetermined time (several seconds, here) has elapsed from when the raster data for prediction (current raster data) shown in FIG. 2 is generated. In the current raster data, traffic light C1 on driving lane A1 is red, and vehicle B3 is partially out of parking space D1 to driving lane A1. Therefore, in the future raster data, vehicles B11, B12 are both predicted to have stopped. In the current raster data, there is no obstacle ahead of moving body 100 and vehicle B13. Therefore, in the future raster data, moving body 100 and vehicle B13 are predicted to have traveled forward by distances corresponding to their respective running velocities.

On the other hand, in the current raster data, vehicles B25, B27, B28, B29 on oncoming driving lane A2 are stopped waiting at the traffic light or due to traffic jam. Therefore, in the future raster data, these vehicles B25, B27 are both predicted to have stopped. Note that, vehicles B28, B29 are out of a certain area with respect to moving body 100 and are therefore not included in the future raster data. Further, in the current raster data, vehicles B21, B23, B24 are all travelling, but ahead of these vehicles B21, B23, B24 there are vehicles B25, B27, B28, B29 stopped. Therefore, in the future raster data, these vehicles B21, B23, B24 are predicted to have stopped, following vehicle B25. Further, in the current raster data, ahead of vehicles B22, B26 on oncoming driving lane A2 there is no obstacle. Therefore, in the future raster data, vehicle B22, B26 are predicted to have traveled by distances corresponding to their respective running velocities.

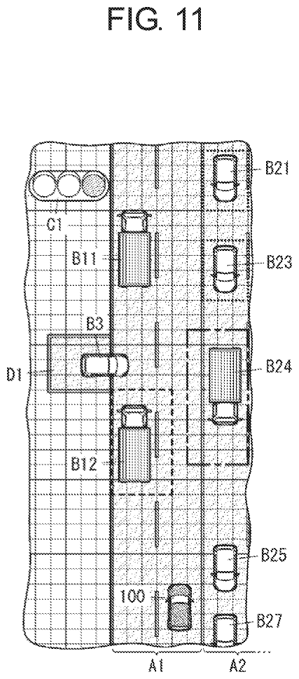

Prediction block 11 predicts, by prediction unit 111, occurrence of an event at the time of generation of the future raster data with a prediction model and the future raster data. Then, when prediction unit 111 predicts an event to occur, prediction block 11 estimates an event occurrence place with the prediction model. Specifically, prediction block 11 calculates, by prediction unit 111, (i) a relative coordinate of a referential pixel of a group of pixels to which the event is predicted to occur in the future raster data (ii) width dimensions of the group of pixels in the X-axis direction and the Y-axis direction. The event occurrence place in the future raster data is the area surrounded by a broken line in FIG. 10. Then, prediction block 11 sets, by prediction unit 111, this group of pixels as an event occurrence place in the current raster data (see the area surrounded by an alternate long and short dash line in FIG. 11). At this time, including an object related to the event occurrence place in the future raster data (the object is vehicles B21, B23, here), the group of pixels may be set as the event occurrence place in the current raster data (see the areas where vehicles B21, B23 are each surrounded by a dotted line in FIG. 11).

Here, the future raster data may be generated by data generator 115 in the data generation processing (step S22) instead of generation of current raster data. In this case, with the future raster data instead of the current raster data, event prediction system 1 executes the prediction processing (step S23), the estimation processing (step S25), and the informing processing (step S26). Specifically, if an event at the time of generation of future raster data is predicted to occur, prediction block 11 sets, by prediction unit 111, the event occurrence places, which is estimated in the future raster data, in the current raster data (see the areas each surrounded by an alternate long and short dash line and a dotted line in FIG. 11). Then, event prediction system 1 notifies, by notification unit 13, of the event occurrence places at the time of generation of the future raster data, in other words, when a predetermined time has elapsed from the time of acquisition of the information for prediction.

The future raster data may be generated by data generator 115 in the data generation processing (step S22) together with generation of the current raster data. In this case, event prediction system 1 executes, in the prediction processing (step S23), both of the prediction processing using the current raster data and the prediction processing using the future raster data.

Here, it is assumed that, as the results of the both types of prediction processing, the event predicted by the prediction processing using the current raster data continues also in the prediction processing using the future raster data. In this case, by prediction unit 111, event prediction system 1 sets, in the current raster data, both of the event occurrence place at the time of generation of the current raster data (see the area surrounded a broken line in FIG. 11) and the event occurrence place at the time of generation of the future raster data. Then, event prediction system 1 notifies of the both of the event occurrence places by notification unit 13. At this time, display forms of the both of the event occurrence places may be differentiated by different colorings, for example.

On the other hand, it is assumed that, as the results of the both types of prediction processing, the event predicted by the prediction processing using the current raster data does not continue in the prediction processing using the future raster data. In this case, event prediction system 1 sets, by prediction unit 111, only the event occurrence place at the time of generation of the future raster data, in the current raster data. Then, event prediction system 1 notifies of the event occurrence place at the time of generation of the future raster data by notification unit 13.

Hereinafter, a description will be given on a specific example of prediction processing and estimation processing using an example of the future raster data shown in FIG. 10. In the case where, in the future raster data, vehicle B3, for example, is about to turn right to enter oncoming driving lane A2, vehicle B3 cannot turn right because oncoming driving lane A2 is blocked by a plurality of vehicles B21, B23. Therefore, event prediction system 1 predicts, by prediction unit 111, that a possibility of vehicle B3 suddenly appearing on the roadway is extremely low and that the event that can occur in the current raster data cannot occur in the future raster data. Then, by prediction unit 111, event prediction system 1 sets, in current raster data, the event occurrence place at the time of generation of the future raster data, but does not set, in the current raster data, the event occurrence place at the time of generation of the current raster data. In this case, event prediction system 1 notifies, by notification unit 13, of only the event occurrence place when a predetermined time has elapsed from the time of acquisition of the information for prediction.

On the other hand, in the case where, in the future raster data, there is a possibility of vehicle B3, for example, turning left to enter driving lane A1, vehicle B3 can enter driving lane A1. Therefore, event prediction system 1 predicts, by prediction unit 111, that there is a possibility of vehicle B3 suddenly appearing on the roadway and that the event that can occur in the current raster data can occur also in the future raster data. Then, by prediction unit 111, event prediction system 1 sets, in the current raster data, both of the event occurrence place at the time of generation of the current raster data and the event occurrence place at the time of generation of the future raster data. In this case, event prediction system 1 notifies, by notification unit 13, of both of the event occurrence place at the time of acquisition of the information for prediction and the event occurrence place when a predetermined time has elapsed from the time of acquisition of the information for prediction.

Event prediction system 1 according to the present exemplary embodiment enables the driver to drive while considering a possibility of occurrence of the event when a predetermined time has elapsed from the time of acquisition of the information for prediction.

### Third Exemplary Embodiment

Event prediction system 1 according to the present exemplary embodiment is different from event prediction system 1 according to the first exemplary embodiment in that prediction unit 111 of the present exemplary embodiment uses a different prediction model for each attribute of a driver driving moving body 100. Hereinafter, components identical to those of the first exemplary embodiment are denoted by the same reference marks and explanations thereof will be omitted.

That is, in the first exemplary embodiment, prediction unit 111 predicts an event with a universally applicable prediction model; however, in the present exemplary embodiment, prediction unit 111 uses a different prediction model for each attribute of a driver. The “attribute of a driver” here includes age, sex, and driving habit (for example, manners of accelerating and braking) of a driver.

In the present exemplary embodiment, learning block 12 acquires history information as data for learning from a plurality of drivers. Model generator 122 generates a prediction model for each attribute of a driver. In an example, model generator 122 generates a prediction model for each attribute of a driver by machine learning using a collaborative filtering algorithm used in a recommended algorithm or the like.

From the thus generated plurality of types of prediction models, a prediction model to be applied (stored in model storage 112) to moving body 100 is chosen. That is, prediction block 11 determines which prediction model to acquire, depending on an attribute of a driver of moving body 100. This enables prediction unit 111 to predict an event with a different prediction model for each attribute of a driver.

Event prediction system 1 according to the present exemplary embodiment improves accuracy of prediction of an event in prediction unit 111, compared with the accuracy of prediction in the case of using a universally applicable prediction model.

In event prediction system 1 according to a modified example of the third exemplary embodiment, a plurality of prediction models are selectively used in one moving body 100. That is, in a case where one moving body 100 is shared in a family or in a case of car sharing, one moving body 100 is driven by a plurality of drivers. In the present modified example, in such a case, a different prediction model can be applied to each driver even when one moving body 100 is used. Specifically, every time a different driver is behind the wheel, prediction block 11 acquires a prediction model corresponding to an attribute of the driver from learning block 12. Alternatively, a plurality of prediction models may be stored in model storage 112 so that prediction unit 111 can choose a prediction model to use from the plurality of prediction models, depending on the attribute of a driver.

Event prediction system 1 according to the third exemplary embodiment (including the modified example) can be configured by appropriately combining the configuration of the first exemplary embodiment (including the modified examples) and the configuration of the second exemplary embodiment.

The drawings illustrated in each exemplary embodiment described above are merely conceptual diagrams of examples of event prediction system 1, and are appropriately different in shapes, sizes, and positional relationships from the actual aspects.

### Overview

As described above, event prediction system (1) according to a first aspect includes accumulation unit (121) and model generator (122). Accumulation unit (121) accumulates a plurality of pieces of data for learning including history information. The history information indicates a situation of moving body (100) at the time of occurrence of an event related to driving of moving body (100). Model generator (122) generates a prediction model for predicting occurrence of the event with the plurality of pieces of data for learning. The history information includes raster data for learning. The raster data for learning indicates, with a plurality of cells, the situation of moving body (100) at the time of occurrence of the event.

With this aspect, a prediction model for predicting occurrence of an event is generated. This aspect has an advantage that using this prediction model makes it possible to predict also occurrence of an event (invisible danger) due to an object in a blind spot of a driver. Therefore, event prediction system (1) can reduce variation in predictability of “invisible danger” depending on driving skills and driving senses of a driver, conditions of a driver, and the like. As a result, for example, even when the drive has relatively little driving experience, the driver can drive considering a possibility of occurrence of such types of events. In addition, even when a driver is less concentrated than usual due to, for example, fatigue and lack of sleep, the driver can drive while considering a possibility of occurrence of such types of events. Further, for example, when a driver simply looks away or is distracted, the driver can take some time finding occurrence of an event. In such a situation, the driver can promptly notice a possibility of occurrence of an event and can therefore drive more safely.

In event prediction system (1) according to a second aspect, the history information in the first aspect further includes at least one of: information about an object in a surrounding area of moving body (100); information about a state of moving body (100); and information about a position of moving body (100).

This aspect enables event prediction system (1) to generate a prediction model in view of moving body (100) and a state of a surrounding area of moving body (100).

In event prediction system (1) according to a third aspect, each of a plurality of pieces of data for learning further includes, in the first or the second aspect, label information indicating an event occurrence place.

This aspect makes it possible not only to predict occurrence of an event but also to generate a prediction model for estimating an event occurrence place.

Event prediction system (1) according to a fourth aspect further includes, in any one of the first to third aspects, data generator (115) and prediction unit (111). Data generator (115) generates raster data for prediction that indicates the situation of moving body (100) with a plurality of cells and with information for prediction about moving body (100). Prediction unit (111) predicts occurrence of an event during driving of moving body (100), with the prediction model and the raster data for prediction.

Since this aspect enables an event to be predicted in event prediction system (1), event prediction system (1) does not have to provide a prediction model to outside, and it is possible to complete processing for predicting occurrence of an event only in event prediction system (1).

In event prediction system (1) according to a fifth aspect, data generator (115) generates, in the fourth aspect, current raster data at the time of acquisition of the information for prediction, as the raster data for prediction. Prediction unit (111) predicts occurrence of an event at the time of generation of the current raster data.

This aspect enables a driver to drive, considering a possibility of occurrence of the event at the time of acquisition of the information for prediction.

In event prediction system (1) according to a sixth aspect, data generator (115) generates, in the fourth or fifth aspect, future raster data as the raster data for prediction on the basis of the current raster data at the time of acquisition of the information for prediction and the information for prediction. The future raster data is data after a predetermined time has elapsed from when the current raster data is generated. Prediction unit (111) predicts occurrence of an event at the time of generation of the future raster data.

This aspect enables a driver to drive while considering a possibility of occurrence of the event when the predetermined time has elapsed from the time of acquisition of the information for prediction.

Event prediction system (1) according to a seventh aspect further includes, in any one of the fourth to sixth aspects, notification unit (13) that notifies of a predicted result of the event.

With this aspect, when an event is predicted to occur, it is noted that there is occurrence of the event; therefore, a driver or the like can drive with careful attention to possible occurrence of an event.

Event prediction system (1) according to an eighth aspect, notification unit (13) has, in the seventh aspect, a display unit that notifies of the predicted result of the event by displaying the predicted result.

This aspect enables the predicted result of an event to be notified by being displayed, and a driver or the like can thus easily identify, for example, an occurrence place of the event.

Event prediction system (1) according to a ninth aspect, prediction unit (111) is configured, in any one of the fourth to eighth aspects, to use the prediction model that is different for each attribute of a driver driving moving body (100).

This aspect improves accuracy of prediction of occurrence of an event in prediction unit (111), compared with the accuracy of prediction in the case of using a universally applicable prediction model.

Event prediction system (1) according to a tenth aspect includes data generator (115) and prediction unit (111). Data generator (115) generates raster data for prediction that indicates a situation of moving body (100) with a plurality of cells and with information for prediction about moving body (100). Prediction unit (111) predicts occurrence of an event, related to driving of moving body (100), during driving of moving body (100) with a prediction model and the raster data for prediction. The prediction model is generated with a plurality of pieces of data for learning including history information indicating a situation of moving body (100) at the time of occurrence of an event. The history information includes raster data for learning that indicates, with a plurality of cells, the situation of moving body (100) at the time of occurrence of an event.

With this aspect, it is possible to predict occurrence of an event with the prediction model. Therefore, event prediction system (1) has an advantage that it is possible to predict also occurrence of an event (invisible danger) due to an object in a blind spot of a driver.

An event prediction method according to an eleventh aspect includes accumulation processing and model generation processing. The accumulation processing accumulates a plurality of pieces of data for learning including history information. The history information indicates a situation of moving body (100) at the time of occurrence of an event related to driving of moving body (100). The model generation processing generates a prediction model for predicting occurrence of an event with the plurality of pieces of data for learning. The history information includes raster data for learning that indicates, with a plurality of cells, the situation of moving body (100) at the time of occurrence of an event.

With this aspect, a prediction model for predicting occurrence of an event is generated. This aspect has an advantage that using this prediction model makes it possible to predict also occurrence of an event (invisible danger) due to an object in a blind spot of a driver. Therefore, the event prediction method can reduce variation in predictability of “invisible danger” depending on driving skills and driving senses of a driver, conditions of a driver, and the like. As a result, for example, even when the drive has relatively little driving experience, the driver can drive considering a possibility of occurrence of such types of events. In addition, even when a driver is less concentrated than usual due to, for example, fatigue and lack of sleep, the driver can drive while considering a possibility of occurrence of such types of events. Further, for example, when a driver simply looks away or is distracted, the driver can take some time finding occurrence of an event. In such a situation, the driver can promptly notice a possibility of occurrence of an event and can therefore drive more safely.

A program according to a twelfth aspect is a program for causing a computer system to execute accumulation processing and model generation processing. The accumulation processing accumulates a plurality of pieces of data for learning including history information. The history information indicates a situation of moving body (100) at a time of occurrence of an event related to driving of moving body (100) and has raster data for learning. The raster data for learning indicates, with a plurality of cells, the situation of moving body (100) at the time of occurrence of the event. The model generation processing generates a prediction model for predicting occurrence of an event with the plurality of pieces of data for learning.

With this aspect, a prediction model for predicting occurrence of an event is generated. This aspect has an advantage that using this prediction model makes it possible to predict also occurrence of an event (invisible danger) due to an object in a blind spot of a driver. Therefore, this program can reduce variation in predictability of “invisible danger” depending on driving skills and driving senses of a driver, conditions of a driver, and the like. As a result, for example, even when the drive has relatively little driving experience, the driver can drive considering a possibility of occurrence of such types of events. In addition, even when a driver is less concentrated than usual due to, for example, fatigue and lack of sleep, the driver can drive while considering a possibility of occurrence of such types of events. Further, for example, when a driver simply looks away or is distracted, the driver can take some time finding occurrence of an event. In such a situation, the driver can promptly notice a possibility of occurrence of an event and can therefore drive more safely.

An event prediction method according to a thirteenth aspect has data generation processing and prediction processing. The data generation processing generates raster data for prediction that indicates a situation of moving body (100) with a plurality of cells and with information for prediction about moving body (100). The prediction processing predicts occurrence of an event, related to driving of moving body (100), during driving of moving body (100) with a prediction model and the raster data for prediction. The prediction model is generated with a plurality of pieces of data for learning including history information indicating a situation of moving body (100) at the time of occurrence of an event. The history information includes raster data for learning that indicates, with a plurality of cells, the situation of moving body (100) at the time of occurrence of an event.

With this aspect, it is possible to predict occurrence of an event with the prediction model. Therefore, event prediction system (1) has an advantage that it is possible to predict also occurrence of an event (invisible danger) due to an object in a blind spot of a driver.

A program according to a fourteenth aspect is a program for causing a computer system to execute data generation processing and prediction processing. The data generation processing generates raster data for prediction that indicates a situation of moving body (100) with a plurality of cells and with information for prediction about moving body (100). The prediction processing predicts occurrence of an event, related to driving of moving body (100), during driving of moving body (100) with a prediction model and the raster data for prediction. The prediction model is generated with a plurality of pieces of data for learning including history information. The history information indicates a situation of moving body (100) at a time of occurrence of an event and has raster data for learning. The raster data for learning indicates, with a plurality of cells, the situation of moving body (100) at the time of occurrence of the event.

With this aspect, it is possible to predict occurrence of an event with the prediction model. Therefore, event prediction system (1) has an advantage that it is possible to predict also occurrence of an event (invisible danger) due to an object in a blind spot of a driver.

Moving body (100) according to a fifteenth aspect includes event prediction system (1) according to any one of the first to tenth aspects.

This aspect has an advantage that moving body (100) can predict also occurrence of an event (invisible danger) due to an object in a blind spot of a driver.

Without being limited to the above aspects, various configurations (including modified examples) of event prediction system (1) according to the first to third exemplary embodiments can be embodied by an event prediction method and a (computer) program.

The configurations according to the second to ninth aspects are not essential configurations for event prediction system (1) and can therefore be appropriately omitted.

### REFERENCE MARKS IN THE DRAWINGS

1: event prediction system
100: moving body
111: prediction unit
115: data generator
121: accumulation unit
122: model generator
13: notification unit
131: 3D-HUD (display unit)
132: 2D-HUD (display unit)
133: meter (display unit)
134: multi-information display (display unit)
11: prediction block
12: learning block
14: ADAS information input unit
15: vehicle information input unit
16: positional information input unit
112: model storage
113: input information processor
114: output information processor
200: cloud
300A: one's vehicle
300B: one's vehicle
300C: one's vehicle
300D: one's vehicle
300E: one's vehicle
300F: one's vehicle
301: truck
301A: truck
301B: truck
301C: truck
301D: truck
301E: truck
301F: truck
302A: truck
302B: truck
302C: pedestrian
302D: vehicle
303A: truck
303B: truck
304A: bicycle
304B: vehicle
304E: vehicle
304F: vehicle
401: marker
401A: marker
401B: marker
401C: marker
401D: marker
401E: marker
401F: marker
501: driving lane
501A: driving lane
501B: driving lane
501C: driving lane
501D: driving lane
501E: driving lane
501F: driving lane
502: oncoming driving lane
502A: oncoming driving lane
502B: oncoming driving lane
502C: oncoming driving lane
502D: oncoming driving lane
502E: oncoming driving lane
502F: oncoming driving lane
503A: sidewalk
503B: sidewalk
503C: sidewalk
504B: traffic light
504C: crosswalk
505B: parking space

1. An event prediction system comprising:
an accumulation unit that accumulates a plurality of pieces of data for learning, wherein the plurality of pieces of data for learning includes history information indicating a situation of a moving body at occurrence of any one of a plurality of events related to driving of the moving body; and
a model generator that generates a prediction model for predicting occurrence of any one of the plurality of events with the plurality of pieces of data for learning,
wherein the history information includes raster data for learning that indicates, with a plurality of cells, a situation of the moving body at occurrence of any one of the plurality of events.

2. The event prediction system according to claim 1, wherein the history information includes at least one of: information about an object in a surrounding area of the moving body; information about a state of the moving body; and information about a position of the moving body.

3. The event prediction system according to claim 1, wherein each of the plurality of pieces of data for learning further includes label information indicating an occurrence place of any one of the plurality of events.

4. The event prediction system according to claim 1, further comprising:
a data generator that generates raster data for prediction that indicates a situation of the moving body with a plurality of cells and with information for prediction about the moving body; and
a prediction unit that predicts occurrence of any one of the plurality of events during driving of the moving body, with the prediction model and the raster data for prediction.

5. The event prediction system according to claim 4, wherein the data generator generates, as the raster data for prediction, current raster data at acquisition of the information for prediction, and
the prediction unit predicts occurrence of any one of the plurality of events at generation of the current raster data.

6. The event prediction system according to claim 4, wherein the data generator generates, as the raster data for prediction, future raster data after a predetermined time has elapsed from when the current raster data is generated, based on the current raster data at acquisition of the information for prediction and based on the information for prediction, and
the prediction unit predicts occurrence, of any one of the plurality of events, at generation of the future raster data.

7. The event prediction system according to claim 4, further comprising a notification unit that notifies of a predicted result of any one of the plurality of events.

8. The event prediction system according to claim 7, wherein the notification unit includes a display unit that notifies of the predicted result of any one of the plurality of events by displaying the predicted result of any one of the plurality of events.

9. The event prediction system according to of claim 4, wherein the prediction unit is configured to use the prediction model that is different for each attribute of a driver driving the moving body.

10. An event prediction system comprising:
a data generator that generates raster data for prediction that indicates a situation of a moving body with a plurality of cells and with information for prediction about the moving body; and
a prediction unit that predicts occurrence of any one of a plurality of events, related to driving of the moving body, during driving of the moving body, with a prediction model and the raster data for prediction,
wherein the prediction model is generated with a plurality of pieces of data for learning including history information indicating a situation of the moving body at occurrence of any one of the plurality of events, and
the history information includes raster data for learning that indicates, with a plurality of cells, a situation of the moving body at occurrence of any one of the plurality of events.

11. An event prediction method comprising:
accumulation processing for accumulating a plurality pieces of data for learning, wherein the plurality pieces of data for learning include history information indicating a situation of a moving body at occurrence of any one of a plurality of events related to driving of the moving body; and
model generation processing for generating a prediction model for predicting occurrence of any one of the plurality of events with the plurality of pieces of data for learning,
wherein the history information includes raster data for learning that indicates, with a plurality of cells, a situation of the moving body at occurrence of any one of the plurality of events.

12. A non-transitory machine-readable recording medium that stores a program for making a computer system execute:
accumulation processing for accumulating a plurality pieces of data for learning, wherein the plurality pieces of data for learning include history information that indicates a situation of a moving body at occurrence of any one of a plurality of events related to driving of the moving body and that includes raster data for learning that indicates, with a plurality of cells, the situation of the moving body at the occurrence of any one of the plurality of events; and
model generation processing for generating a prediction model for predicting occurrence of any one of the plurality of events with the plurality of pieces of data for learning.

13. An event prediction method comprising:
data generation processing for generating raster data for prediction that indicates a situation of a moving body with a plurality of cells and with information for prediction about the moving body; and
prediction processing for predicting occurrence of any one of a plurality of events, related to driving of the moving body, during driving of the moving body, with a prediction model and the raster data for prediction,
wherein the prediction model is generated with a plurality of pieces of data for learning including history information indicating a situation of the moving body at occurrence of any one of the plurality of events, and
the history information includes raster data for learning that indicates, with a plurality of cells, a situation of the moving body at occurrence of any one of the plurality of events.

14. A non-transitory machine-readable recording medium that stores a program for making a computer system execute:
data generation processing for generating raster data for prediction that indicates a situation of a moving body with a plurality of cells and with information for prediction about the moving body; and
prediction processing for predicting occurrence of any one of events, related to driving of the moving body, during driving of the moving body, with:
a prediction model generated with a plurality of pieces of data for learning that include history information that indicates a situation of the moving body at occurrence of an event and that include raster data for learning that indicates, with a plurality of cells, the situation of the moving body at the occurrence of the event; and
the raster data for prediction.

15. A moving body comprising the event prediction system according to claim 1.
